(19) United States
(12) Patent Application Publication
(10) Pub. No.: US 2026/0309582 A1
(43) Pub. Date: Oct. 8, 2026

(54) EXHAUST FUME MONITORING ON AUTONOMOUS TRUCKS

(71) Applicant: Torc Robotics, Inc., Blacksburg, VA (US)

(72) Inventor: Fridtjof Stein, Ostfildern (DE)

(21) Appl. No.: 19/172,134

(22) Filed: Apr. 7, 2025

(51) Int. Cl. G01M 15/10; B60R 1/22

(52) U.S. Cl. CPC G01M 15/102; B60R 1/22; B60R 2300/80

(57) ABSTRACT

Exhaust fumes can be used to identify mechanical issues within vehicles, including autonomous vehicles. A monitoring system receives, from a sensor mounted on an external surface of an autonomous vehicle, data associated with a physical condition of the autonomous vehicle. The monitoring system identifies one or more characteristics of the physical condition based on the data. The one or more characteristics are indicative of a function of the autonomous vehicle. The monitoring system determines, based on the one or more characteristics, one or more actions for the autonomous vehicle. The monitoring system transmits the one or more characteristics to a central computing system associated with a fleet of autonomous vehicles, where the fleet of autonomous vehicles includes at least the autonomous vehicle.

### TECHNICAL FIELD

The field of the disclosure relates generally to autonomous vehicles and, more specifically, to monitoring exhaust fumes of autonomous vehicles.

### BACKGROUND OF THE INVENTION

Diagnosing engine problems based on exhaust fumes involves analyzing the color, odor, and composition of the emissions to identify potential issues. Unusual exhaust colors, such as black, white, or blue smoke, can indicate incomplete combustion, coolant leakage, or oil burning, respectively. Changes in exhaust odor, such as a strong fuel smell or a burning scent, may suggest fuel system malfunctions or overheating components. Excessive emissions or irregular exhaust flow patterns can also indicate inefficiencies in combustion, air-fuel mixture imbalances, or component wear.

This section is intended to introduce the reader to various aspects of art that may be related to various aspects of the present disclosure described or claimed below. This description is believed to be helpful in providing the reader with background information to facilitate a better understanding of the various aspects of the present disclosure. Accordingly, it should be understood that these statements are to be read in this light and not as admissions of prior art.

### SUMMARY OF THE INVENTION

In one aspect, the disclosed monitoring system may receive, from a sensor mounted on an external surface of an autonomous vehicle, data associated with a physical condition of the autonomous vehicle. The physical condition may be associated with exhaust fumes of the autonomous vehicle. The monitoring system may identify one or more characteristics of the physical condition based on the data. The one or more characteristics may be indicative of a function of the autonomous vehicle. The monitoring system may determine, based on the one or more characteristics, one or more actions for the autonomous vehicle. The monitoring system may transmit the one or more characteristics to a central computing system associated with a fleet of autonomous vehicles, where the fleet of autonomous vehicles may include at least the autonomous vehicle.

In another aspect, a system for monitoring exhaust fumes is disclosed. The system may include a sensor mounted on an external surface of an autonomous vehicle. The sensor may be configured to monitor a physical condition of the autonomous vehicle. The physical condition may be associated with exhaust fumes of the autonomous vehicle. The system may also include a light emitting diode (LED) directed at the physical condition that enables the sensor to monitor the physical condition of the autonomous vehicle. The system may also include one or more processors and a memory storing instructions that, when executed by the one or more processors, receive, from a sensor mounted on an external surface of an autonomous vehicle, data associated with a physical condition of the autonomous vehicle. The system may identify one or more characteristics of the physical condition based on the data. The one or more characteristics may be indicative of a function of the autonomous vehicle. The monitoring system may determine, based on the one or more characteristics, one or more actions for the autonomous vehicle. The monitoring system may transmit the one or more characteristics to a central computing system associated with a fleet of autonomous vehicles, where the fleet of autonomous vehicles may include at least the autonomous vehicle.

In yet another aspect, a non-transitory computer-readable storage medium may include instructions that when executed by one or more processors, may cause the one or more processors to receive, from a sensor mounted on an external surface of an autonomous vehicle, data associated with a physical condition of the autonomous vehicle. The physical condition may be associated with exhaust fumes of the autonomous vehicle. The one or more processors may identify one or more characteristics of the physical condition based on the data. The one or more characteristics may be indicative of a function of the autonomous vehicle. The one or more processors may determine, based on the one or more characteristics, one or more actions for the autonomous vehicle. The one or more processors may transmit the one or more characteristics to a central computing system associated with a fleet of autonomous vehicles, where the fleet of autonomous vehicles may include at least the autonomous vehicle.

Various refinements exist of the features noted in relation to the above-mentioned aspects. Further features may also be incorporated in the above-mentioned aspects as well. These refinements and additional features may exist individually or in any combination. For instance, various features discussed below in relation to any of the illustrated examples may be incorporated into any of the above-described aspects, alone or in any combination.

### BRIEF DESCRIPTION OF DRAWINGS

The following drawings form part of the present specification and are included to further demonstrate certain aspects of the present disclosure. The disclosure may be better understood by reference to one or more of these drawings in combination with the detailed description of specific embodiments presented herein.

FIG. 1 illustrates a schematic view of an autonomous truck according to some aspects of the present disclosure.

FIG. 2 illustrates a block diagram of the autonomous truck shown in FIG. 1 according to some aspects of the present disclosure.

FIG. 3 illustrates a block diagram of an exhaust monitoring module for implementing a monitoring system associated with the autonomous truck according to some aspects of the present disclosure.

FIG. 4 illustrates an example implementation of the monitoring system according to some aspects of the present disclosure.

FIG. 5 illustrates an example implementation of the monitoring system according to some aspects of the present disclosure.

FIG. 6 illustrates a flow diagram of an example method of monitoring vehicle exhaust according to some aspects of the present disclosure.

FIG. 7 illustrates a block diagram of an example computing system according to some aspects of the present disclosure.

Corresponding reference characters indicate corresponding parts throughout the several views of the drawings. Although specific features of various examples may be shown in some drawings and not in others, this is for convenience only. Any feature of any drawing may be referenced or claimed in combination with any feature of any other drawing.

Some structural or method features may be shown in specific arrangements and/or orderings in the drawings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, it may not be included or may be combined with other features.

### DETAILED DESCRIPTION

The following detailed description and examples set forth preferred materials, components, and procedures used in accordance with the present disclosure. This description and these examples, however, are provided by way of illustration only, and nothing therein shall be deemed to be a limitation upon the overall scope of the present disclosure.

Monitoring exhaust characteristics of an autonomous vehicle enables early detection of potential engine faults and can improve performance, efficiency, and longevity of the autonomous vehicle. Analyzing the color of exhaust fumes is used for diagnosing engine problems, as different colors can reveal specific underlying issues. Black smoke often suggests an overly rich fuel mixture, where excess fuel is not properly burned, potentially due to a faulty fuel injector, air intake restriction, or sensor malfunction. White smoke may indicate coolant entering the combustion chamber, which could result from a blown head gasket, a cracked engine block, or a damaged cylinder head. Blue or gray smoke is typically a sign of oil burning within the engine, which may be caused by worn piston rings, valve seals, or turbocharger issues. Normal exhaust should be nearly invisible or light gray, and any persistent color abnormality can serve as an early warning of mechanical or combustion inefficiencies, allowing for timely maintenance and repairs.

Identifying the state of exhaust fumes (e.g., color, smell, appearance, etc.) is typically performed by a driver operating a non-autonomous (or semi-autonomous) vehicle. A driver may observe the exhaust fumes (e.g., through a rear-view mirror directed towards an exhaust pipe) and identify any abnormalities. In a typical implementation of an autonomous vehicle, there is not a driver (or other human able to observe the exhaust fumes) within the autonomous vehicle. Thus, on an autonomous vehicle, it is difficult to ascertain the condition of the exhaust fumes without an observer and quickly identify potential mechanical issues. In some other implementations, a driver of a non-autonomous (or semi-autonomous) vehicle may be unable to check the exhaust fumes of the vehicle due to physical impairments of the driver, size of the vehicle, physical size of the driver (e.g., height), placement of the exhaust pipe, placement of windows, any combination thereof, or the like.

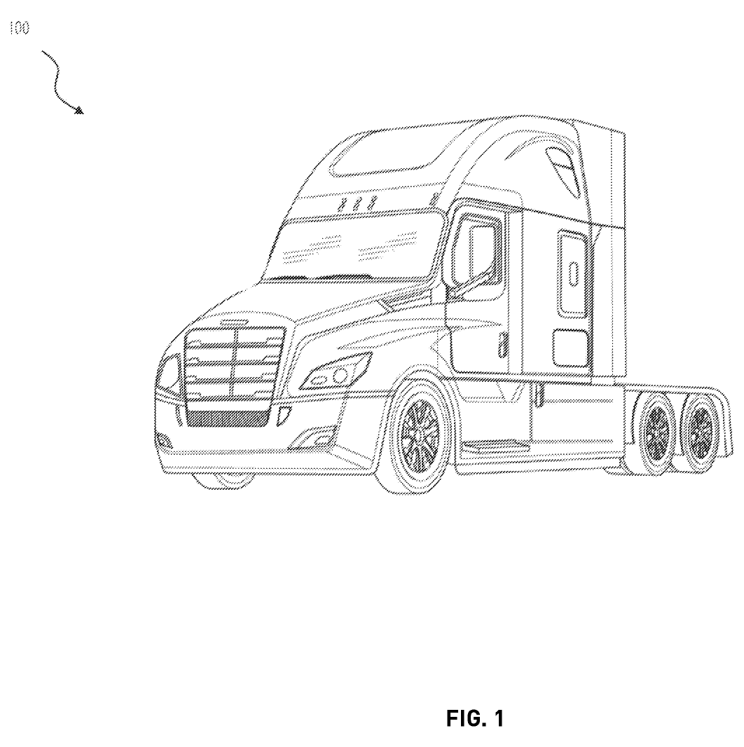

A monitoring system disclosed herein provides a method of observing exhaust fumes in a vehicle. Although an autonomous vehicle is discussed throughout the specification and respective figures, it should not be construed as limiting, as the monitoring system can also be implemented in non-autonomous vehicles and semi-autonomous vehicles to assist drivers (and passengers) with observing exhaust fumes from a vehicle. The disclosed monitoring system can include a camera may be mounted on an external surface of an autonomous vehicle (e.g., an autonomous truck, as illustrated in FIG. 1) and may be directed towards the exit of the exhaust pipe. Such a camera monitors the exhaust coming out of the exit of the exhaust pipe and identifies a color associated with the exhaust. A representation of the color is transmitted to an internal computing system that determines whether the color may be indicative of a mechanical issue with the autonomous vehicle. In some examples, the internal computing system utilizes one or more machine learning models to predict whether the color may be indicative of a mechanical issue. If the color is determined to indicate a potential mechanical issue, the internal computing system can generate one or more actions for the autonomous vehicle to assist in remedying the potential mechanical issue. The actions may include, for example, pulling over immediately, pulling over at the nearest truck stop, notifying a mechanic associated with the autonomous vehicle, initiate additional testing on a perceived problem area, any combination thereof, or the like.

In certain embodiments, the internal computing system may transmit the color and/or the one or more actions associated with the autonomous vehicle to a central controller, or “mission control,” configured to manage a fleet of autonomous vehicles. The central controller may maintain a database that contains data associated with the fleet of autonomous vehicles, such as exhaust fume data. The central controller may store the color and/or one or more actions in the database in association with the autonomous vehicle. The database may be used by an administrator of the central controller (e.g., a manager of the fleet of vehicles, a mechanic for the fleet of vehicles, etc.) to identify potential repairs that will need to be performed on the fleet of autonomous vehicles.

FIG. 1 illustrates a vehicle 100, such as a truck that may be conventionally connected to a single or tandem trailer to transport the trailer (not shown) to a desired location. Vehicle 100 includes a cabin that can be supported by, and steered in the required direction, by front wheels and rear wheels that are partially shown in FIG. 1. Front wheels are positioned by a steering system that includes a steering wheel and a steering column (not shown in FIG. 1). The steering wheel and the steering column may be located in the interior of a cabin.

The vehicle 100 may be an autonomous vehicle, in which case vehicle 100 may omit the steering wheel and the steering column to steer vehicle 100. Rather, vehicle 100 may be operated by an autonomy computing system (not shown) of vehicle 100 based on data collected by a sensor network (not shown in FIG. 1) including one or more sensors.

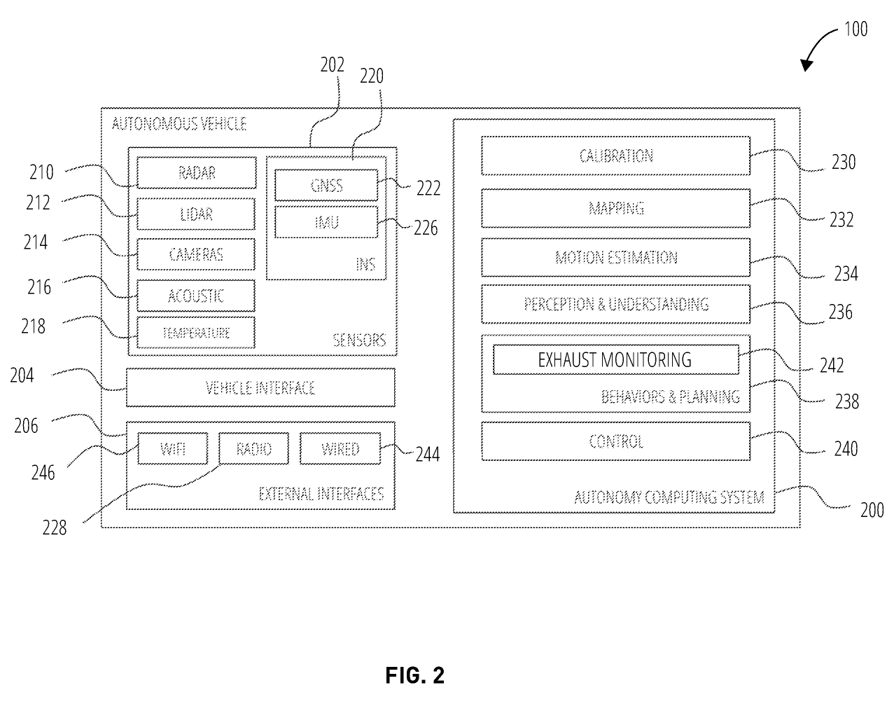

FIG. 2 is a block diagram of autonomous vehicle 100 shown in FIG. 1. In the example embodiment, autonomous vehicle 100 includes autonomy computing system 200, sensors 202, a vehicle interface 204, and external interfaces 206.

In the example embodiment, sensors 202 may include various sensors such as, for example, radio detection and ranging (RADAR) sensors 210, light detection and ranging (LiDAR) sensors 212, cameras 214, acoustic sensors 216, temperature sensors 218, or inertial navigation system (INS) 220, which may include one or more global navigation satellite system (GNSS) receivers 222 and one or more inertial measurement units (IMU) 226. Other sensors 202 not shown in FIG. 2 may include, for example, acoustic (e.g., ultrasound), internal vehicle sensors, meteorological sensors, or other types of sensors. Sensors 202 generate respective output signals based on detected physical conditions of autonomous vehicle 100 and its proximity. As described in further detail below, these signals may be used by autonomy computing system 200 to determine how to control operations of autonomous vehicle 100.

Cameras 214 are configured to capture images of the environment surrounding autonomous vehicle 100 in any aspect or field of view (FOV). The FOV can have any angle or aspect such that images of the areas ahead of, to the side, behind, above, or below autonomous vehicle 100 may be captured. In some embodiments, the FOV may be limited to particular areas around autonomous vehicle 100 (e.g., forward of autonomous vehicle 100, to the sides of autonomous vehicle 100, etc.) or may surround 360 degrees of autonomous vehicle 100. In some embodiments, autonomous vehicle 100 includes multiple cameras 214, and the images from each of multiple cameras 214 may be processed to identify one or more construction markers or other objects in the environment surrounding autonomous vehicle 100. In some embodiments, the image data generated by cameras 214 may be sent to autonomy computing system 200 or other aspects of autonomous vehicle 100 or a hub or both.

LiDAR sensors 212 generally include a laser generator and a detector that send and receive a LiDAR signal such that LiDAR point clouds (or “LiDAR images”) of the areas ahead of, to the side, behind, above, or below autonomous vehicle 100 can be captured and represented in the LiDAR point clouds. RADAR sensors 210 may include short-range RADAR (SRR), mid-range RADAR (MRR), long-range RADAR (LRR), or ground-penetrating RADAR (GPR). One or more sensors may emit radio waves, and a processor may process received reflected data (e.g., raw RADAR sensor data) from the emitted radio waves. In some embodiments, the system inputs from cameras 214, RADAR sensors 210, or LiDAR sensors 212 may be used in combination to identify one or more construction markers (or nodes) around autonomous vehicle 100.

GNSS receiver 222 is positioned on autonomous vehicle 100 and may be configured to determine a location of autonomous vehicle 100, which it may embody as GNSS data. GNSS receiver 222 may be configured to receive one or more signals from a global navigation satellite system (e.g., Global Positioning System (GPS) constellation) to localize autonomous vehicle 100 via geolocation. In some embodiments, GNSS receiver 222 may provide an input to or be configured to interact with, update, or otherwise utilize one or more digital maps, such as an HD map (e.g., in a raster layer or other semantic map). In some embodiments, GNSS receiver 222 may provide direct velocity measurement via inspection of the Doppler effect on the signal carrier wave. Multiple GNSS receivers 222 may also provide direct measurements of the orientation of autonomous vehicle 100. For example, with two GNSS receivers 222, two attitude angles (e.g., roll and yaw) may be measured or determined. In some embodiments, autonomous vehicle 100 is configured to receive updates from an external network (e.g., a cellular network). The updates may include one or more of position data (e.g., serving as an alternative or supplement to GNSS data), speed/direction data, orientation or attitude data, traffic data, weather data, or other types of data about autonomous vehicle 100 and its environment.

IMU 226 is a micro-electrical-mechanical (MEMS) device that measures and reports one or more features regarding the motion of autonomous vehicle 100, although other implementations are contemplated, such as mechanical, fiber-optic gyro (FOG), or FOG-on-chip (SiFOG) devices. IMU 226 may measure an acceleration, angular rate, or an orientation of autonomous vehicle 100 or one or more of its individual components using a combination of accelerometers, gyroscopes, or magnetometers. IMU 226 may detect linear acceleration using one or more accelerometers and rotational rate using one or more gyroscopes and attitude information from one or more magnetometers. In some embodiments, IMU 226 may be communicatively coupled to one or more other systems, for example, GNSS receiver 222 and may provide input to and receive output from GNSS receiver 222 such that autonomy computing system 200 is able to determine the motive characteristics (acceleration, speed/direction, orientation/attitude, etc.) of autonomous vehicle 100.

In the example embodiment, autonomy computing system 200 employs vehicle interface 204 to send commands to the various aspects of autonomous vehicle 100 that actually control the motion of autonomous vehicle 100 (e.g., engine, throttle, steering wheel, brakes, etc.) and to receive input data from one or more sensors 202 (e.g., internal sensors). External interfaces 206 are configured to enable autonomous vehicle 100 to communicate with an external network via, for example, a wired or wireless connection, such as Wi-Fi 246 or other radios 228. In embodiments including a wireless connection, the connection may be a wireless communication signal (e.g., Wi-Fi, cellular, LTE, 5G, Bluetooth, etc.).

In some embodiments, external interfaces 206 may be configured to communicate with an external network via a wired connection 244, such as, for example, during testing of autonomous vehicle 100 or when downloading mission data after completion of a trip. The connection(s) may be used to download and install various lines of code in the form of digital files (e.g., HD maps), executable programs (e.g., navigation programs), and other computer-readable code that may be used by autonomous vehicle 100 to navigate or otherwise operate, either autonomously or semi-autonomously. The digital files, executable programs, and other computer readable code may be stored locally or remotely and may be routinely updated (e.g., automatically, or manually) via external interfaces 206 or updated on demand. In some embodiments, autonomous vehicle 100 may deploy with all of the data it needs to complete a mission (e.g., perception, localization, and mission planning) and may not utilize a wireless connection or other connections while underway.

In the example embodiment, autonomy computing system 200 is implemented by one or more processors and memory devices of autonomous vehicle 100. Autonomy computing system 200 includes modules, which may be hardware components (e.g., processors or other circuits) or software components (e.g., computer applications or processes executable by autonomy computing system 200), configured to generate outputs, such as control signals, based on inputs received from, for example, sensors 202. These modules may include, for example, a calibration module 230, a mapping module 232, a motion estimation module 234, a perception and understanding module 236, a behaviors and planning module 238, a control module or controller 240, and an exhaust monitoring module 242. Exhaust monitoring module 242, for example, may be embodied within another module, such as behaviors and planning module 238, or separately. These modules may be implemented in dedicated hardware such as, for example, an application specific integrated circuit (ASIC), field programmable gate array (FPGA), or microprocessor, or implemented as executable software modules, or firmware, written to memory and executed on one or more processors onboard autonomous vehicle 100.

Exhaust monitoring module 242 may perform one or more tasks including, but not limited to receiving data associated with exhaust fumes of autonomous vehicle 100, determine if the exhaust fumes are indicative of a potential mechanical problem within autonomous vehicle 100, generate one or more actions to remedy the potential mechanical problem, and transmit data pertaining to the exhaust fumes and/or the potential mechanical problem to a central controller associated with autonomous vehicle 100. In some examples, exhaust monitoring module 242 may manage monitoring sessions associated with autonomous vehicle 100, such as handling instructions from external components instructing exhaust monitoring module 242 to initiate a monitoring session, managing a timer associated with a cadence for initiating monitoring sessions, any combination thereof, or the like.

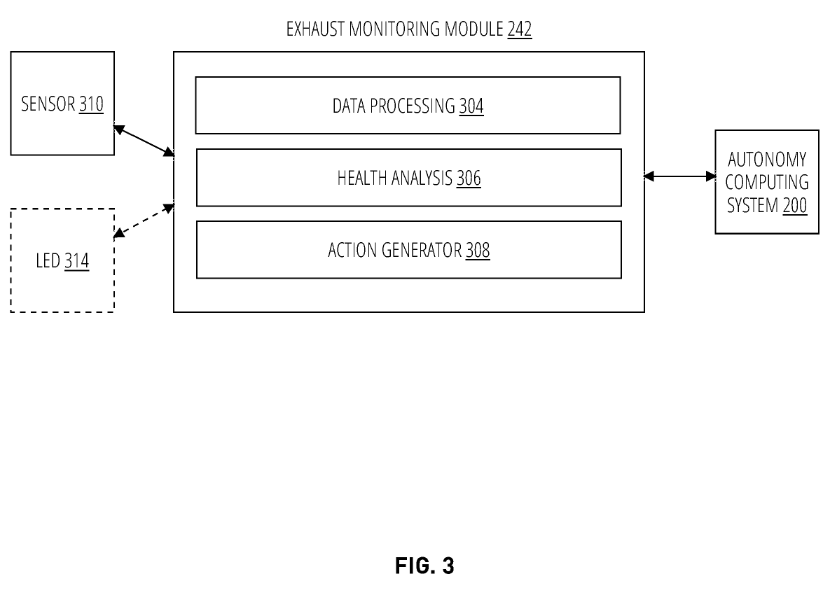

FIG. 3 illustrates a block diagram of an exhaust monitoring module for implementing a monitoring system associated with the autonomous truck according to some aspects of the present disclosure. Exhaust monitoring module 242 may include one or more internal modules, including, but not limited to, data processing 304, health analysis 306, and action generator 308. The internal modules of exhaust monitoring module 242 may operate alone or in combination to perform the functionality of exhaust monitoring module 242, including, but not limited to, monitoring a physical condition (e.g., exhaust fumes) of autonomous vehicle 100 by receiving sensor data from a sensor (e.g., sensor 310) mounted on autonomous vehicle 100, determining if there is likely a mechanical issue within autonomous vehicle 100 based on the characteristics of the physical condition, and generating one or more actions (for output to autonomy computing system 200) for autonomous vehicle 100 based on the potential mechanical issue.

Exhaust monitoring module 242 may be, as indicated above in FIG. 2, implemented on an internal computing system within autonomous vehicle 100. Exhaust monitoring module 242 may operate locally within autonomous vehicle 100 but may communicate to a central computing system associated with the autonomous vehicle. For example, autonomous vehicle 100 may be one of a fleet of autonomous vehicles associated with an organization, operation, business, enterprise, task, any combination thereof, or the like. The central computing system may manage the fleet of autonomous vehicles and respective monitoring system modules (e.g., a first autonomous vehicles is associated with a first monitoring system, a second autonomous vehicle is associated with a second monitoring system, autonomous vehicle 100 is associated with exhaust monitoring module 242, etc.). To manage the fleet of autonomous vehicles, the central computing system may maintain a database that includes the fleet of autonomous vehicles and respective data for the autonomous vehicles of the fleet of autonomous vehicles. In some examples, the database may include a custom data structure configured to efficiently maintain records associated with the individual autonomous vehicles of the fleet of autonomous vehicles. For example, the database may include a combination of relational tables or NoSQL documents used to store physical conditions of the autonomous vehicles, identification numbers, maintenance records, recommended maintenance, performance metrics, etc. The database may utilized indexed key-value pairs, time-series logs, or hierarchical JSON/XML formats to optimize data retrieval, real-time monitoring, and historical analysis.

The database may be populated with data pertaining to exhaust monitoring module 242 and autonomous vehicle 100. Exhaust monitoring module 242 may transmit results associated with a monitoring session conducted on autonomous vehicle 100. The monitoring session may be a period of time designated by autonomous vehicle 100 (e.g., autonomy computing system 200), the central computing system, an individual associated with the maintenance of autonomous vehicle 100, any combination thereof, or the like, where exhaust monitoring module 242 monitors the exhaust fumes produced by autonomous vehicle 100. In some examples, the monitoring session may be initiated by a timer (e.g., maintained at autonomous vehicle 100 and/or the central computing system) that designates a cadence for conducting monitoring sessions (e.g., every hour, every 30 minutes, once a day, etc.), initiated by a signal from a sensor within autonomous vehicle 100 (e.g., high temperature identified in the engine, low oil level, fuel injector failure, etc.), initiated remotely at the central computing system (e.g., manually initiated at individual vehicles of the fleet of vehicles by an administrator of the central computing system), any combination thereof, or the like.

In some examples, a monitoring session is successfully initiated when one or more requirements are met. For example, one or more requirements may include, but are not limited to, autonomous vehicle 100 being powered on (e.g., engine ignited, battery operational, etc.), a drive time (e.g., a duration of time since a last stop time of autonomous vehicle 100 must meet a threshold value, etc.), an external environment requirement (e.g., snow, heavy rain, strong winds, etc.), an internal engine temperature (e.g., the engine must reach a threshold temperature), any combination thereof, or the like. The one or more requirements may be determined by autonomy computing system 200, the central computing system, an administrator of autonomy computing system 200 and/or the central computing system, any combination thereof, or the like. Before initiating the monitoring session, exhaust monitoring module 242 may verify that the one or more requirements are met (e.g., by querying one or more relevant modules, such as sensors 202, mapping module 232, motion estimation module 234, any combination thereof, or the like). For example, if autonomy computing system 200 initiates a monitoring session, exhaust monitoring module 242 may verify that autonomous vehicle 100 is turned on and has been driving for at least 30 minutes. If autonomous vehicle 100 is not currently turned on and operational, or has not been driving for at least 30 minutes, exhaust monitoring module 242 may transmit an error signal to autonomy computing system 200.

When the monitoring session is initiated, one or more components associated with exhaust monitoring module 242 may be activated (e.g., “turned on,” begin sensing data, begin operations, etc.). Exhaust monitoring module 242 may transmit a signal to sensor 310 indicating that the monitoring session is initiated. For example, at the initiation of the monitoring session, exhaust monitoring module 242 may transmit a signal to sensor 310 and sensor 310 may begin generating and transmitting data associated with the exhaust fumes of autonomous vehicle 100. In some implementations of exhaust monitoring module 242, LED 314 may operate in conjunction with sensor 310. Similarly, at the initiation of the monitoring session, LED 314 may begin illuminating at least the exhaust fumes of autonomous vehicle 100 and/or a portion of autonomous vehicle 100 (or in the immediate vicinity of autonomous vehicle 100) that is in the path of exhaust fumes (e.g., at the exit of an exhaust pipe). In some examples, LED 314 may be automatically and/or manually adjusted to illuminate the exhaust fumes and/or the portion of autonomous vehicle 100 that is in the path of the exhaust fumes. By illuminating the exhaust fumes, LED 314 enables sensor 310 to accurately produce data associated with a physical condition of the exhaust fumes (e.g., color). However, in some examples, LED 314 may be disabled due to one or more external conditions (e.g., a threshold level of light in the environment surrounding autonomous vehicle 100, provided by sources such as daylight, moonlight, street lights, tunnel lights, headlights, ambient light, any combination thereof, or the like) and sensor 310 may ascertain the physical condition of the exhaust fumes without the illumination provided by LED 314.

A duration of the monitoring session may be determined by a configuration associated with exhaust monitoring module 242. The configuration may be from a setting of exhaust monitoring module 242, autonomous vehicle 100, and/or the central computing system. For example, an administrator of the central computing system may designate the duration to be five seconds, 10 seconds, 30 seconds, or one minute. At the conclusion of the duration of time, LED 314 and sensor 310 may be deactivated (e.g., “turned off," stop sensing data, stop illuminating the exhaust fumes, etc.).

During the monitoring session, the sensor 310 may generate data associated with the physical condition (e.g., exhaust fumes) and transmit data associated with the physical condition to data processing 304. Sensor 310 may be a sensor, including, but not limited to, an RGB photodetector, multispectral sensor, hyperspectral sensor, CMOS or CCD image sensors, spectrophotometers, etc. In some examples, sensor 310 may be a camera, including, but not limited to, an RGB camera, multispectral camera, hyperspectral camera, industrial color camera, etc. In some examples, sensor 310 may be a combination of a camera and/or a sensor apparatus. For example, a camera associated with sensor 310 may capture an image with full color information and a sensor associated with sensor 310 may detect and analyze light properties (e.g., without forming an image).

Data processing 304 may receive physical condition data from sensor 310 in the form of raw data. The raw data may be transmitted to data processing 304 at a certain frequency as determined by sensor 310 (e.g., through settings associated with sensor 310, through settings associated with exhaust monitoring module 242, through settings associated with the central computer system, etc.). Data processing 304 may normalize the raw data, transform the raw data, and/or otherwise modify the raw data to be usable by health analysis 306. For example, data processing 304 may apply calibration, filtering, and data conversion algorithms to the raw data, transforming it into a standardized format that can be interpreted and utilized by health analysis 306. In some examples, data processing 304 may also maintain a historical database associated with the standardized raw data of sensor 310. For example, data processing 304 may be configured to save standardized raw data associated with a number of monitoring sessions (e.g., 100, 1000, etc.), a period of time (e.g., one month, six months, etc.), data associated with a specific value (e.g., saving data associated with a representation of a specific color, etc.), any combination thereof, or the like. The historical database may be stored locally on autonomous vehicle 100 or may be stored remotely at a location accessible to data processing 304 (e.g., cloud database, remote database associated with the central computing system, etc.).

Data processing 304 may transmit the standardized raw data representative of the physical condition to health analysis 306. Health analysis 306 may analyze the standardized raw data and identify one or more characteristics of the physical condition based on the standardized raw data. Health analysis 306 may utilize the one or more characteristics to identify potential mechanical problems associated with autonomous vehicle 100 based on the one or more characteristics. For example, health analysis 306 may identify a potential mechanical problem based on the color (e.g., a characteristic) of exhaust fumes (e.g., the physical condition). The potential mechanical problems may be a faulty fuel injector, air intake restriction, or sensor malfunction (e.g., resulting in an overly rich fuel mixture, indicated by black exhaust); may be a block head gasket, cracked engine block, or damaged cylinder head (e.g., resulting in coolant entering the combustion chamber, indicated by white exhaust); may be worn piston rings, valve seals, or turbocharger issues (e.g., resulting in oil burning within the engine, indicated by blue or gray exhaust); and/or may be any other component of autonomous vehicle 100 that may impact the functionality of autonomous vehicle 100. In some examples, health analysis 306 may not identify a potential mechanical problem based on the one or more characteristics. For example, the exhaust fumes (e.g., the physical condition) may be light gray or white (e.g., a characteristic), which is considered a “normal” color for exhaust fumes and does not immediately indicate a potential problem.

The one or more characteristics based on the physical condition may be determined by a series of thresholds associated with health analysis 306. The series of thresholds may define ranges of values that may be indicative of a potential mechanical problem. For example, the series of thresholds may be configured to indicate a color and/or an urgency. The series of thresholds may be defined by the central computing system (e.g., by an administrator or mechanic associated with management of autonomous vehicle 100) or may be defined at autonomous vehicle 100 (e.g., by a mechanic and/or other manager of autonomous vehicle 100) to specifically calibrate the series of thresholds to autonomous vehicle 100. When health analysis 306 receives the standardized raw data from data processing 304, health analysis 306 may compare the standardized raw data to the series of thresholds and identify where the standardized raw data falls within the series of thresholds (if at all). For example, health analysis 306 may compare the standardized raw data to a first series of thresholds to identify a first characteristic (e.g., a color), then may compare the standardized raw data to a second series of thresholds to identify a second characteristic (e.g., an urgency). Through the comparison of the standardized raw data to the series of thresholds, health analysis 306 may identify one or more characteristics of the physical condition represented by the standardized raw data. For example, health analysis 306 may determine that a first set of raw data falls within a lower threshold and an upper threshold for indicating “white.” Health analysis 306 may also determine that the first set of raw data falls within a lower threshold and an upper threshold for indicating “medium urgency.” Therefore, the one or more characteristics of the physical condition associated with the first set of raw data are “white” and “medium urgency.”

In some examples, health analysis 306 may compare the standardized raw data to historical standardized raw data. During a monitoring session, health analysis 306 may compare current standardized raw data with the standardized raw data stored in the historical database. The comparison of the current standardized raw data and the historical database may produce a difference. The difference may be compared to the series of thresholds to determine if the difference represents a characteristic that may be indicative of a potential mechanical problem. Health analysis 306 may utilize a difference in value between the current standardized raw data and the standardized raw data stored in the historical database (e.g., values indicative of “light gray” compared to values indicative of “dark gray”), a comparison between metadata associated with the current standardized raw data and the standardized raw data stored in the historical database (e.g., a time), any combination thereof, or the like.

In some examples, health analysis 306 may employ one or more machine-learning models trained to analyze sensor data and identify the one or more characteristics of the physical condition, determine the potential mechanical problem, and/or a level of urgency. The one or more machine learning models may receive the standardized raw data and be trained to analyze the standardized raw data to identify one or more characteristics of the physical condition that may be indicative of a potential mechanical problem. In some examples, the one or more machine learning models may receive additional data, including, but not limited to, engine data (e.g., noise profile, rotations-per-minute (RPM), temperature, slope angle, etc.), vehicle data (e.g., weight, axes, length, etc.), external data (e.g., outside temperature, barometric readings, wind speed, precipitation level, etc.), any combination thereof, or the like. The additional data may supplement the standardized raw data. For example, the one or more machine learning models may analyze the standardized raw data and the additional data to generate a more accurate prediction of the potential mechanical problem.

Examples of one or more machine learning models include algorithms such as k-means clustering algorithms, fuzzy c-means (FCM) algorithms, expectation-maximization (EM) algorithms, hierarchical clustering algorithms, density-based spatial clustering of applications with noise (DBSCAN) algorithms, and the like. Other examples of machine learning or artificial intelligence algorithms include, but are not limited to, genetic algorithms, backpropagation, reinforcement learning, decision trees, linear classification, artificial neural networks, anomaly detection, and such. More generally, machine learning or artificial intelligence methods may include regression analysis, dimensionality reduction, meta-learning, reinforcement learning, deep learning, and other such algorithms and/or methods. For example, a first machine learning model of the one or more machine learning models (e.g., such as a deep learning-based convolutional neural network (CNN), a vision transformer (ViT), and/or a recurrent neural network (RNN)) could analyze color by extracting spatial and spectral features from an image, converting RGB or hyperspectral data into feature maps that represent color variations. In some other examples, the first machine learning model (e.g., a transformer-based model, a support vector machine (SVM), and/or a Gaussian mixture model (GMM)) could process sequential or clustered color data by embedding pixel intensity distributions and learning contextual relationships to classify, segment, or predict color changes over time.

In some instances, the one or more machine learning models may be trained using training data received and/or derived from standardized raw data, additional data (e.g., engine data, vehicle data, external data, etc.), and/or respective confirmed mechanical problems. In some examples, the first machine-learning model may be trained using training data received and/or derived from historical data (e.g., the standardized raw data stored in the historical database) associated with prior monitoring sessions associated with health analysis 306. In some examples, the prior monitoring sessions may be associated with autonomous vehicle 100, the fleet of autonomous vehicles, any combination thereof, or the like. For example, a first machine-learning model may be trained using data associated with other implementations of health analysis 306 (e.g., an instance of health analysis 306 associated with the individual autonomous vehicles of the fleet of autonomous vehicles). The one or more machine learning models can be trained using supervised training, supervised training, semi-supervised training, reinforcement training, combinations thereof, or the like.

For example, the one or more machine learning models may be trained using transfer learning. Transfer learning is a technique in machine learning where a one or more machine learning models initially trained to solve a particular task is used as the starting point for a different task. Transfer learning can be useful when the second task is somewhat similar to the first task, or when there is limited training data available for the second task. For example, one or more machine learning models initially trained to generate one or more characteristics may be further trained to predict a potential mechanical problem based on the one or more characteristics. Further, the one or more machine learning models initially trained to predict a potential mechanical problem may be further trained to generate one or more actions associated with autonomous vehicle 100 necessary to mitigate the potential mechanical problem. In some instances, health analysis 306 may access a pre-trained model and “fine-tune” the pre-trained model by training the pre-trained model on a second training dataset. The second training dataset can include training data that includes standardized raw data that is associated with a confirmed mechanical problem, one or more characteristics, and one or more actions associated with the confirmed mechanical problem. To further fine-tune the one or more machine learning models, health analysis 306 reconfigures the one or more machine learning models to include additional hidden and/or output layers to recognize information necessary to complete a particular action. In some instances, fine-tuning the pre-trained model includes unfreezing some of the layers of the pre-trained model and training them on the new training dataset. The number of layers that are unfrozen can depend on the size of the new dataset and how similar it is to the original dataset. For example, the fine-tuning of the first machine-learning model can include freezing the weights of the first machine-learning model, to train the first machine-learning model to predict a potential mechanical problem based on one or more characteristics of the physical condition. Then, the weights can be unfrozen such that the first machine-learning model can be trained to improve accuracy of the potential mechanical problem. By improving accuracy of the one or more machine learning models, this reduces the processing load on computers associated with health analysis 306 by reducing the number of iterations necessary to gather information necessary to complete an action. Further, this reduces the likelihood that irrelevant information is gathered and processed, thereby reducing a processing load on the system.

Health analysis 306 transmits the one or more characteristics of the physical condition to action generator 308. Action generator 308, based on the one or more characteristics, generates one or more actions for autonomous vehicle 100. In some examples, the one or more actions may be generated by the one or more machine learning models. For example, the one or more machine learning models may be further trained to generate one or more actions to mitigate the impact of the potential mechanical problem on autonomous vehicle 100 (e.g., mitigate vehicle damage, mitigate fuel costs, mitigate mechanic costs, etc.). The one or more actions may include, but are not limited to, message transmission (e.g., notifying the central computing system of a potential mechanical issue and a relevant urgency), instructions for changing a current route (e.g., pulling over immediately, finding a nearest truck stop, changing a route to pass a mechanic, changing a route to return to a starting location, changing a route to expedite a trip, etc.), instructions for altering the mechanical operations of autonomous vehicle 100 (e.g., speed/acceleration/RPM limitations, etc.), any combination thereof, or the like. Action generator 308 may transmit the one or more actions to autonomy computing system 200 for implementation in autonomous vehicle 100.

Exhaust monitoring module 242 may continue to monitor the physical condition for the duration of the monitoring session. Throughout the monitoring session, exhaust monitoring module 242 may transmit at least one of the standardized raw data, the one or more characteristics, and the one or more actions to central computing system. Central computing system may store information received from exhaust monitoring module 242 in the database configured to store data associated with the fleet of autonomous vehicles that comprises at least autonomous vehicle 100.

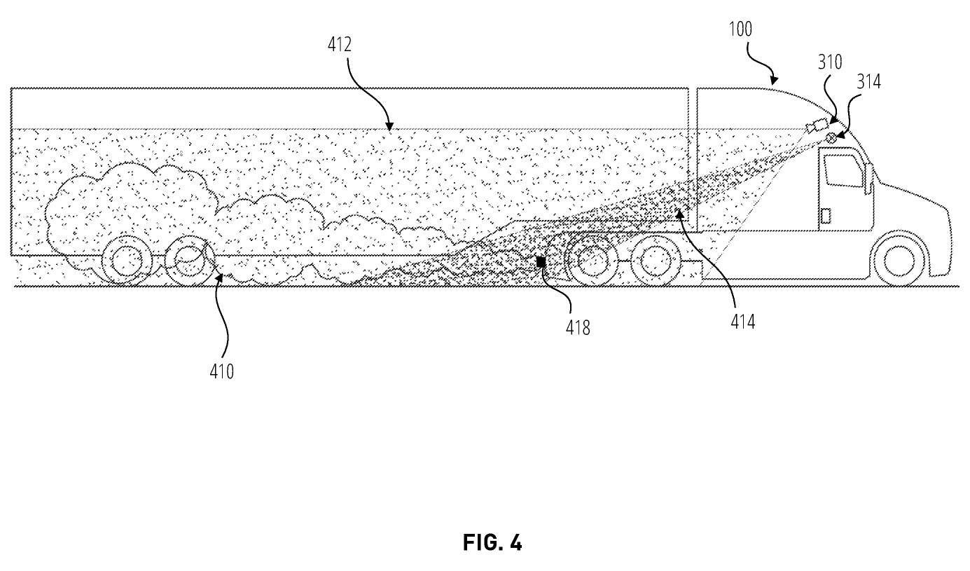

FIG. 4 illustrates an example implementation of the monitoring system according to some aspects of the present disclosure. As described in the foregoing, sensor 310 and/or LED 314 may be affixed to autonomous vehicle 100. As shown in FIG. 4, sensor 310 and/or LED 314 may be affixed to an external surface of autonomous vehicle 100, but in other embodiments, sensor 310 and/or LED 314 may be affixed to an internal (or otherwise) surface of autonomous vehicle 100 (e.g., on the inside of the cabin, on the underside of autonomous vehicle 100, any combination thereof, or the like. During a monitoring session, sensor 310 may monitor a physical condition associated with autonomous vehicle 100 (e.g., exhaust fumes 410). Sensor 310 may be configured with a viewing frustum (e.g., viewing frustrum 412), which defines a region of autonomous vehicle 100 (or an area in immediate vicinity of autonomous vehicle 100) that is visible to sensor 310. Viewing frustrum 412 may be defined by a field of view, aspect ratio, near clipping planes, far clipping planes, any combination thereof, or the like, which are associated with sensor 310. Objects within viewing frustrum 412 (e.g., the physical condition, such as exhaust fumes 410) will be detected and monitored by sensor 310. In some examples, viewing frustrum 412 may be configured and/or calibrated to monitor a smaller area, thereby producing increasingly specific data associated with the physical condition.

LED 314 may be directed towards the physical condition (e.g., exhaust fumes) and may illuminate a portion (e.g., illumination 414) of autonomous vehicle 100 (or an area in immediate vicinity of autonomous vehicle 100) associated with the physical condition. By providing light (e.g., via illumination 414) to the portion of autonomous vehicle 100 associated with the physical condition, LED 314 improves the ability of sensor 310 to monitor the physical condition.

Autonomous vehicle 100 illustrated in FIG. 4 includes exhaust pipe 418 that protrudes from a bottom portion of autonomous vehicle 100. Therefore, viewing frustum 412 of sensor 310 is directed towards the bottom portion of autonomous vehicle 100 to capture exhaust pipe 418. Similarly, LED 314 is directed towards exhaust pipe 418 protruding from the bottom portion of autonomous vehicle 100. During a monitoring session, LED 314 may be activated to illuminate (via illumination 414) the physical condition and sensor 310 may monitor the physical condition.

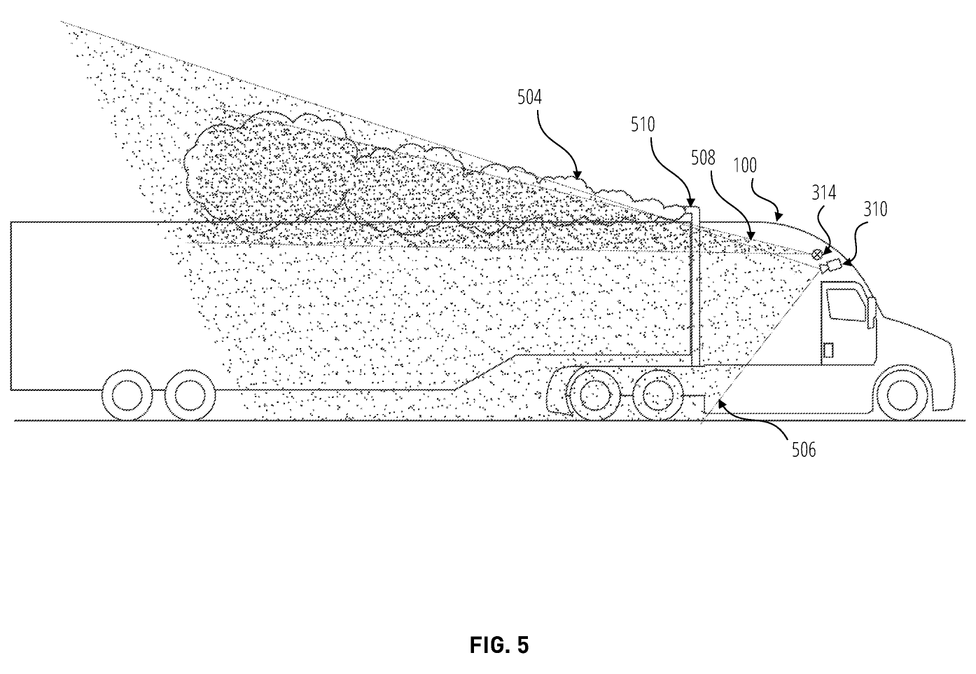

FIG. 5 illustrates an example implementation of the monitoring system according to some aspects of the present disclosure. Similar to the embodiment of FIG. 4, the autonomous vehicle shown in FIG. 5 includes sensor 310 (and viewing frustrum 506) and LED 314 (and illumination 508). However, FIG. 5 illustrates exhaust pipe 510 that protrudes from the top portion of autonomous vehicle 100. Therefore, viewing frustum 506 of sensor 310 is directed towards the top portion of autonomous vehicle 100 to capture exhaust fumes 504 coming from exhaust pipe 510. Similarly, LED 314 is directed towards exhaust pipe 510 protruding from the top portion of autonomous vehicle 100. During a monitoring session, LED 314 may be activated to illuminate (via illumination 508) the physical condition and sensor 310 may monitor the physical condition (e.g., exhaust fumes 504).

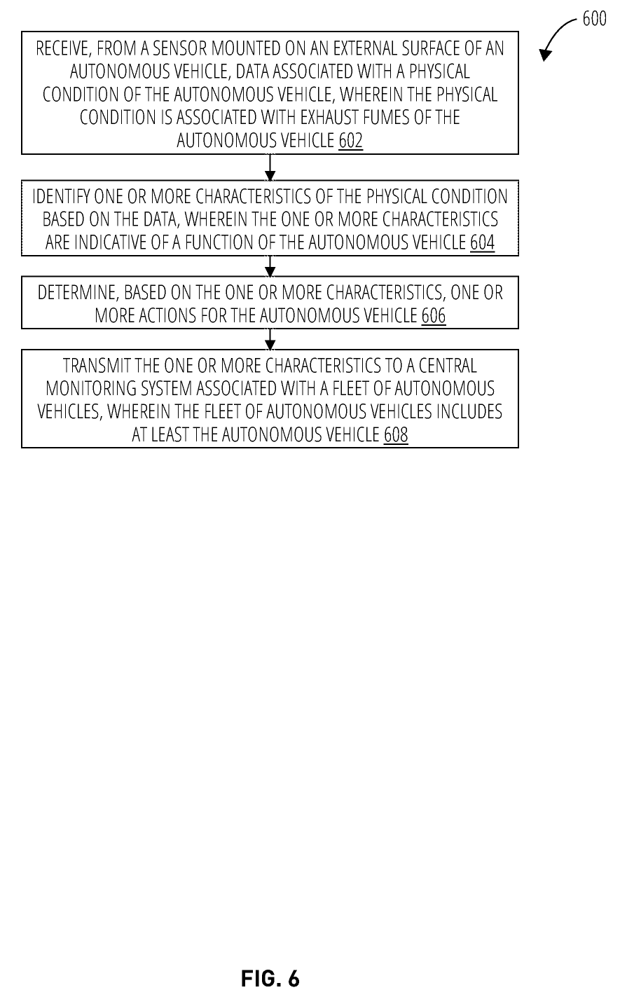

FIG. 6 is a flowchart of a method 600 of monitoring vehicle exhaust according to some aspects of the present disclosure. Method 600 may be embodied, for example, in an autonomous vehicle, such as autonomous vehicle 100 shown in FIGS. 1, 2, 4, and 5, or in exhaust monitoring module 242 shown in FIGS. 2 and 3.

Method 600 includes receiving 602, from a sensor mounted on an external surface of an autonomous vehicle, data associated with a physical condition of the autonomous vehicle. For example, exhaust monitoring module 242 (e.g., as described in FIGS. 2 and 3) may receive, from sensor 310 (e.g., as described in FIG. 3) mounted on the external surface of autonomous vehicle 100 (e.g., as described in FIGS. 1 and 2), data associated with the physical condition of autonomous vehicle 100. During a monitoring session, the sensor may transmit raw data associated with the physical condition to a monitoring system associated with the autonomous vehicle. The raw data may be standardized by the monitoring system (e.g., calibrated, filtered, normalized, transformed, or otherwise modified).

Method 600 includes identifying 604 one or more characteristics of the physical condition based on the data, wherein the one or more characteristics are indicative of a function of the autonomous vehicle. For example, exhaust monitoring module 242 may identify one or more characteristics of the physical condition based on the data, wherein the one or more characteristics are indicative of a function of the autonomous vehicle. The monitoring system may process the standardized raw data to determine if the raw data indicates a potential mechanical issue that impacts the functionality of the autonomous vehicle. In some examples, the monitoring system may employ one or more machine learning models to process the standardized raw data. For example, the monitoring system may compare the standardized raw data to a pre-determined series of thresholds. The series of thresholds may define ranges of values that may be indicative of a potential mechanical problem that could impact the function of the autonomous vehicle.

For example, the monitoring system may compare the standardized raw data to a first series of thresholds to identify a first characteristic (e.g., a color), then may compare the standardized raw data to a second series of thresholds to identify a second characteristic (e.g., an urgency). Through the comparison of the standardized raw data to the series of thresholds, the monitoring system may identify one or more characteristics of the physical condition represented by the standardized raw data. For example, the monitoring system may determine that a first set of raw data falls within a lower threshold and an upper threshold for indicating “white.” The monitoring system may also determine that the first set of raw data falls within a lower threshold and an upper threshold for indicating “medium urgency.” Therefore, the one or more characteristics of the physical condition associated with the first set of raw data are “white” and “medium urgency.”

Method 600 includes determining 606, based on the one or more characteristics, one or more actions for the autonomous vehicle. For example, exhaust monitoring module 242 may determine, based on the one or more characteristics, one or more actions for autonomous vehicle 100. The one or more actions may include, but are not limited to, message transmission (e.g., notifying a central computing system of a potential mechanical issue and a relevant urgency), instructions for changing a current route (e.g., pulling over immediately, finding a nearest truck stop, changing a route to pass a mechanic, changing a route to return to a starting location, changing a route to expedite a trip, etc.), instructions for altering the mechanical operations of the autonomous vehicle (e.g., speed/acceleration/RPM limitations, etc.), any combination thereof, or the like. In some examples, the monitoring system may employ one or more machine learning models to generate the one or more actions. The monitoring system may transmit the one or more actions to a computing system associated with the autonomous vehicle for implementation in the autonomous vehicle.

Method 600 includes transmitting 608 the one or more characteristics to a central computing system associated with a fleet of autonomous vehicles, wherein the fleet of autonomous vehicles includes at least the autonomous vehicle. For example, exhaust monitoring module 242 may transmit the one or more characteristics to the central computing system associated with a fleet of autonomous vehicles, where the fleet of autonomous vehicles includes autonomous vehicle 100. To manage the fleet of autonomous vehicles, the central computing system may maintain a database that includes the fleet of autonomous vehicles and respective data for the autonomous vehicles of the fleet of autonomous vehicles. In some examples, the database may include a custom data structure configured to efficiently maintain records associated with the individual autonomous vehicles of the fleet of autonomous vehicles. For example, the database may include a combination of relational tables or NoSQL documents used to store physical conditions of the autonomous vehicles, identification numbers, maintenance records, recommended maintenance, performance metrics, etc. The database may utilized indexed key-value pairs, time-series logs, or hierarchical JSON/XML formats to optimize data retrieval, real-time monitoring, and historical analysis.

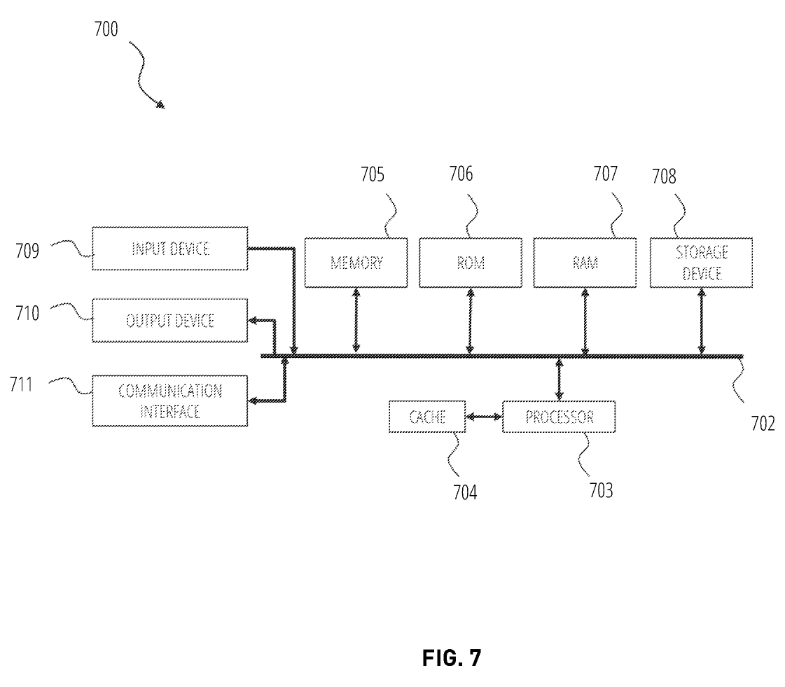

FIG. 7 illustrates an example computing system 700 that can implement various techniques, processes, functions, or methods described herein. The components of computing system 700 are shown in electrical communication with each other using a connection 702, such as a bus. The example computing system 700 includes a processing unit (or processor) 703 and a computing device connection 701 that couples various computing device components, including computing device memory 705, such as a read only memory ROM 706 and a random access memory RAM 707, to processor 703.

Computing system 700 can include a cache 704 of high-speed memory connected directly with, in close proximity to, or integrated as part of processor 810. Computing system 700 can copy data from memory 705 and/or storage device 708 to cache 704 for quick access by processor 703. In this way, cache 704 can provide a performance boost that avoids processor 703 delays while waiting for data. These and other modules can control or be configured to control processor 703 to perform various actions. Other computing device memory 705 may be available for use as well. Memory 705 can include multiple different types of memory with different performance characteristics. Processor 703 can include any general purpose processor, central processing unit (CPU), or graphics processing unit (GPU) in combination with a hardware or software provision configured to control processor 703 and stored in storage device 708, as well as any special-purpose processor where software instructions are incorporated into the processor design. Processor 703 may be a self-contained system, containing multiple cores or processors, a bus, memory controller, cache, etc. A multi-core processor may be symmetric or asymmetric.

Storage device 708 is a non-volatile memory and can be one or more of a hard disk or other types of computer readable media that can store data that are accessible by a computer, such as a magnetic cassette, flash memory card, solid state memory device, digital versatile disk, cartridge, RAM 707, ROM 706, or hybrids thereof. Memory 705 or storage device 708 can include software, code, firmware, etc., for controlling processor 703. Other hardware or software modules are contemplated. Memory 705 and storage device 708 are connected to computing device connection 701. In one aspect, a hardware module that performs a particular function can include the software component stored in a computer-readable medium in connection with the necessary hardware components, such as processor 703, computing device connection 701, and so forth, to carry out the function. In the example embodiment, processor 703 may be programmed by encoding an operation or function using one or more executable instructions and providing the executable instructions in memory 705 or storage device 708.

To enable user interaction, computing system 700 includes an input device 709, which can represent any number of input mechanisms, such as a microphone for speech, a touch-sensitive screen for gesture or graphical input, keyboard, mouse, motion input, speech, etc. Computing system 700 can also include output device 710, which can be one or more of a number of output mechanisms known to those of skill in the art. In some instances, multimodal systems can enable a user to provide multiple types of input/output to communicate with computing system 700. Computing system 700 can include communication interface 711, which can generally govern and manage the user input and system output. There is no restriction on operating on any particular hardware arrangement, and therefore the basic features here may easily be substituted for improved hardware or firmware arrangements as they are developed.

In operation, a computer executes computer-executable instructions embodied in one or more computer-executable components stored on one or more computer-readable media to implement aspects of the disclosure described or illustrated herein. The order of execution or performance of the operations in embodiments of the disclosure illustrated and described herein is not essential, unless otherwise specified. That is, the operations may be performed in any order, unless otherwise specified, and embodiments of the disclosure may include additional or fewer operations than those disclosed herein. For example, it is contemplated that executing or performing a particular operation before, contemporaneously with, or after another operation is within the scope of aspects of the disclosure.

An example technical effect of the methods, systems, and apparatus described herein includes at least one of: (a) efficient monitoring of a physical condition of a vehicle, (b) expedient identification of potential mechanical issues within a vehicle, (c) ease of installation using components that are already in use for autonomous and/or semi-autonomous vehicles, and (e) reduced risk of exacerbating mechanical issues of a vehicle.

Some embodiments involve the use of one or more electronic processing or computing devices. As used herein, the terms “processor” and “computer” and related terms, e.g., “processing device,” and “computing device” are not limited to just those integrated circuits referred to in the art as a computer, but broadly refers to a processor, a processing device or system, a general purpose central processing unit (CPU), a graphics processing unit (GPU), a microcontroller, a microcomputer, a programmable logic controller (PLC), a reduced instruction set computer (RISC) processor, a field programmable gate array (FPGA), a digital signal processor (DSP), an application specific integrated circuit (ASIC), and other programmable circuits or processing devices capable of executing the functions described herein, and these terms are used interchangeably herein. These processing devices are generally “configured” to execute functions by programming or being programmed, or by the provisioning of instructions for execution. The above examples are not intended to limit in any way the definition or meaning of the terms processor, processing device, and related terms.

The various aspects illustrated by logical blocks, modules, circuits, processes, algorithms, and algorithm steps described above may be implemented as electronic hardware, software, or combinations of both. Certain disclosed components, blocks, modules, circuits, and steps are described in terms of their functionality, illustrating the interchangeability of their implementation in electronic hardware or software. The implementation of such functionality varies among different applications given varying system architectures and design constraints. Although such implementations may vary from application to application, they do not constitute a departure from the scope of this disclosure.

Aspects of embodiments implemented in software may be implemented in program code, application software, application programming interfaces (APIs), firmware, middleware, microcode, hardware description languages (HDLs), or any combination thereof. A code segment or machine-executable instruction may represent a procedure, a function, a subprogram, a program, a routine, a subroutine, a module, a software package, a class, or any combination of instructions, data structures, or program statements. A code segment may be coupled to, or integrated with, another code segment or an electronic hardware by passing or receiving information, data, arguments, parameters, memory contents, or memory locations. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the claimed features or this disclosure. Thus, the operation and behavior of the systems and methods were described without reference to the specific software code being understood that software and control hardware can be designed to implement the systems and methods based on the description herein.

When implemented in software, the disclosed functions may be embodied, or stored, as one or more instructions or code on or in memory. In the embodiments described herein, memory includes non-transitory computer-readable media, which may include, but is not limited to, media such as flash memory, a random access memory (RAM), read-only memory (ROM), erasable programmable read-only memory (EPROM), electrically erasable programmable read-only memory (EEPROM), and non-volatile RAM (NVRAM). As used herein, the term “non-transitory computer-readable media” is intended to be representative of any tangible, computer-readable media, including, without limitation, non-transitory computer storage devices, including, without limitation, volatile and non-volatile media, and removable and non-removable media such as a firmware, physical and virtual storage, CD-ROM, DVD, and any other digital source such as a network, a server, cloud system, or the Internet, as well as yet to be developed digital means, with the sole exception being a transitory propagating signal. The methods described herein may be embodied as executable instructions, e.g., “software” and “firmware,” in a non-transitory computer-readable medium. As used herein, the terms “software” and “firmware” are interchangeable and include any computer program stored in memory for execution by personal computers, workstations, clients, and servers. Such instructions, when executed by a processor, configure the processor to perform at least a portion of the disclosed methods.

As used herein, an element or step recited in the singular and proceeded with the word “a” or “an” should be understood as not excluding plural elements or steps unless such exclusion is explicitly recited. Furthermore, references to “one embodiment” of the disclosure or an “exemplary” or “example” embodiment are not intended to be interpreted as excluding the existence of additional embodiments that also incorporate the recited features. Likewise, limitations associated with “one embodiment” or “an embodiment” should not be interpreted as limiting to all embodiments unless explicitly recited.

Disjunctive language such as the phrase “at least one of X, Y, or Z,” unless specifically stated otherwise, is generally intended, within the context presented, to disclose that an item, term, etc. may be either X, Y, or Z, or any combination thereof (e.g., X, Y, and/or Z). Likewise, conjunctive language such as the phrase “at least one of X, Y, and Z,” unless specifically stated otherwise, is generally intended, within the context presented, to disclose at least one of X, at least one of Y, and at least one of Z.

Although certain embodiments have been illustrated and described herein for ‎purposes of description, a wide variety of alternate and/or equivalent embodiments or ‎implementations calculated to achieve the same purposes may be substituted for the ‎embodiments shown and described without departing from the scope of the present disclosure. ‎This application is intended to cover any adaptations or variations of the embodiments ‎discussed herein, including the implementation or utilization of components of the systems or steps independently and separately from other described components or steps. Therefore, it is manifestly intended that embodiments described herein be ‎limited only by the claims.

What is claimed is:

1. A method of monitoring vehicle exhaust, the method comprising:
receiving, from a sensor mounted on an external surface of an autonomous vehicle, data associated with a physical condition of the autonomous vehicle, wherein the physical condition is associated with exhaust fumes of the autonomous vehicle;
identifying one or more characteristics of the physical condition based on the data, wherein the one or more characteristics are indicative of a function of the autonomous vehicle;
determining, based on the one or more characteristics, one or more actions for the autonomous vehicle; and
transmitting the one or more characteristics to a central computing system associated with a fleet of autonomous vehicles, wherein the fleet of autonomous vehicles includes at least the autonomous vehicle.

2. The method of claim 1, further comprising:
transmitting the one or more actions to an autonomous computing system, wherein the autonomous computing system generates commands for implementing the one or more actions for the autonomous vehicle.

3. The method of claim 1, wherein the one or more characteristics include a color associated with the physical condition.

4. The method of claim 1, wherein when the one or more characteristics are received by the central computing system, the central computing system stores a record in a database of the one or more characteristics in association with the autonomous vehicle.

5. The method of claim 4, wherein the central computing system maintains the database, and wherein the database includes a plurality of records associated with a plurality of autonomous vehicles.

6. The method of claim 1, wherein the sensor is a camera.

7. The method of claim 1, further comprising:
initiating a monitoring session associated with a monitoring system of the autonomous vehicle; and
upon initiating the monitoring session, activating a light emitting diode (LED) directed at the physical condition.

8. The method of claim 7, further comprising:
upon initiating the monitoring session, activating the sensor to begin monitoring the physical condition of the autonomous vehicle.

9. A monitoring system comprising:
a sensor mounted on an external surface of an autonomous vehicle, wherein the sensor is configured to monitor a physical condition of the autonomous vehicle, wherein the physical condition is associated with exhaust fumes of the autonomous vehicle;
a light emitting diode (LED) directed at the physical condition, wherein the LED enables the sensor to monitor the physical condition of the autonomous vehicle;
one or more processors; and
a memory storing instructions that, when executed by the one or more processors, configure the monitoring system to:
receive, from the sensor, data associated with the physical condition of the autonomous vehicle;
identify one or more characteristics of the physical condition based on the data, wherein the one or more characteristics are indicative of a function of the autonomous vehicle;
determine, based on the one or more characteristics, one or more actions for the autonomous vehicle; and
transmit the one or more characteristics to a central computing system associated with a fleet of autonomous vehicles, wherein the fleet of autonomous vehicles includes at least the autonomous vehicle.

10. The monitoring system of claim 9, further comprising:
an autonomous computing system, wherein the autonomous computing system generates commands for implementing the one or more actions for the autonomous vehicle.

11. The monitoring system of claim 9, wherein the one or more characteristics include a color associated with the physical condition.

12. The monitoring system of claim 9, wherein when the one or more characteristics are received by the central computing system, the central computing system stores a record in a database of the one or more characteristics in association with the autonomous vehicles.

13. The monitoring system of claim 12, wherein the central computing system maintains the database, and wherein the database includes a plurality of records associated with a plurality of autonomous vehicles.

14. The monitoring system of claim 9, wherein the sensor is a camera.

15. The monitoring system of claim 9, wherein the instructions further configure the one or more processors to:
initiate a monitoring session associated with the monitoring system of the autonomous vehicle; and
upon initiating the monitoring session, activating the LED directed at the physical condition.

16. The monitoring system of claim 15, wherein the instructions further configure the one or more processors to:
upon initiating the monitoring session, activating the sensor to begin monitoring the physical condition of the autonomous vehicle.

17. A non-transitory computer-readable storage medium, the non-transitory computer-readable storage medium including instructions that when executed by one or more processors, cause the one or more processors to:
receive, from a sensor mounted on an external surface of an autonomous vehicle, data associated with a physical condition of the autonomous vehicle, wherein the physical condition is associated with exhaust fumes of the autonomous vehicle;
identify one or more characteristics of the physical condition based on the data, wherein the one or more characteristics are indicative of a function of the autonomous vehicle;
determine, based on the one or more characteristics, one or more actions for the autonomous vehicle; and
transmit the one or more characteristics to a central computing system associated with a fleet of autonomous vehicles, wherein the fleet of autonomous vehicles includes at least the autonomous vehicle.

18. The non-transitory computer-readable storage medium of claim 17, wherein the instructions further configure the one or more processors to:
transmit the one or more actions to an autonomous computing system, wherein the autonomous computing system generates commands for implementing the one or more actions for the autonomous vehicle.

19. The non-transitory computer-readable storage medium of claim 17, wherein the instructions further configure the one or more processors to:
initiate a monitoring session associated with a monitoring system of the autonomous vehicle; and
upon initiating the monitoring session, activate a light emitting diode (LED) directed at the physical condition.

20. The non-transitory computer-readable medium of claim 19, wherein the instructions further configure the one or more processors to:
upon initiating the monitoring session, activate the sensor to begin monitoring the physical condition of the autonomous vehicle.
